(19) United States
(12) Patent Application Publication
(10) Pub. No.: US 2021/0265695 A1
(43) Pub. Date: Aug. 26, 2021

(54) BATTERY FOR A MOTOR VEHICLE AND CORRESPONDING MOTOR VEHICLE

(71) Applicant: AUDI AG, Ingolstadt (DE)

(72) Inventors: Marvin CZECH, Ingolstadt (DE); Andreas DEINDL, Grossmehring (DE); Sönke KÜHL, Dossenheim (DE); Jürgen STEGMAIER, Kirchberg (DE)

(73) Assignee: AUDI AG, Ingolstadt (DE)

(21) Appl. No.: 17/174,520

(22) Filed: Feb. 12, 2021

(30) Foreign Application Priority Data
Feb. 20, 2020 (DE) 10 2020 104 454.2

(51) Int. Cl. H01M 50/282; H01M 50/24; H01M 50/276; H01M 50/249; H01M 10/653; H01M 10/613; H01M 10/6551; H01M 10/625

(52) U.S. Cl. CPC H01M 50/282; H01M 50/24; H01M 50/276; H01M 50/249; H01M 2220/20; H01M 10/613; H01M 10/6551; H01M 10/625; H01M 10/653

(57) ABSTRACT

A battery for a motor vehicle the battery includes a plurality of battery cells arranged in an interior of a battery housing. The battery housing includes a housing cover having a layer composite, which includes an electromagnetically shielding envelope layer and a metal plate arranged thereon. The metal plate is thermally and/or mechanically more stable than the envelope layer and faces toward the interior of the battery housing, so that the envelope layer is protected from a gas jet and/or fire jet escaping from the respective battery cell in case of damage.

### BACKGROUND

The invention relates to a battery for a motor vehicle. The battery according to the invention includes a plurality of battery cells and a battery housing having a housing cover, wherein each of the plurality of battery cells is arranged in an interior of the battery housing. In addition, the present invention relates to a corresponding motor vehicle.

A battery in the meaning of the invention is preferably a so-called high-voltage battery, which is configured to provide an electrical voltage in the range of greater than 60 V, in particular in the range of several hundred volts. It is preferably used in an at least partially electrically drivable motor vehicle, wherein it provides electrical drive energy for driving the motor vehicle. The high voltages required for this purpose in the above-mentioned range are achieved in that a plurality of battery cells are electrically conductively interconnected with one another. Such a battery cell preferably provides a voltage in the range between 3.5 and 4 V here.

Damage, for example an internal short-circuit can occur here in the battery cell, in particular in the galvanic cell. Due to the chemical reaction resulting therefrom, a gas mixture, the composition of which is dependent on a respective cell chemistry, can form and accumulate in an interior of a battery cell housing. A battery cell internal pressure increased above a predetermined operating pressure can build up within the damaged battery cell due to the gas development. This damage-related chemical reaction moreover results in strong heating of the affected battery cell in comparison to a normal temperature range or a standard operating temperature of the battery cell.

Various approaches are known from the prior art for avoiding a short-circuit or thermally isolating a damaged battery cell which is heating up.

For example, DE 10 2016 015 029 A1 and DE 10 2017 104 711 A1 each disclose a multilayered cover of a battery housing. According to the first-mentioned document, a thermoplastic plastic foam can be arranged between two metallic layers, and according to the second-mentioned document, a fiber-reinforced plastic body having fire retardant fillers can be arranged between two metallic layers. Good heat distortion resistance and good fire protection behavior can thus be achieved.

Furthermore, DE 10 2017 216 673 A1 discloses an electrochemical energy storage device having a cell housing, which includes a housing cover made of steel and/or aluminum. An insulation layer made of plastic and/or artificial resin can be applied to the housing in order to reduce an electrical interaction between the cell housing and the environment.

The gas development caused by the increased battery cell internal pressure can have the result that gas escapes from the battery cell in the form of a gas jet and/or fire jet. The known and mentioned solutions do enable effective thermal and/or electrical insulation of a battery cell and/or a battery housing, but for the case of escape of the gas jet and/or fire jet from the battery cell housing of the damaged battery cell into an interior of the battery housing enclosing the battery cell, disadvantageously no further protective measures, in particular mechanical protective measures are provided.

### SUMMARY

The invention is based on the object of providing an improved battery housing for a battery of the type mentioned at the outset. In particular, a housing cover is to be implemented here which enables effective thermal and/or mechanical insulation of the damaged battery cell(s) even in the event of damage-related escape of a gas jet and/or fire jet and thus maintains an integrity of the battery housing at least for a predetermined time interval after occurrence of damage.

Advantageous refinements of the invention are described by the following description, and the figure.

The invention is based on the finding here that a housing cover of a battery housing which comprises a thermally insulating layer does provide effective thermal insulation, but has no or only minor resistance to mechanical strain. In particular, a housing cover constructed in this way has little or no mechanical resistance to a damage-related escape of a gas jet and/or fire jet.

A battery for a motor vehicle is provided by the invention. Corresponding to the above-described type, the battery includes a plurality of battery cells and a battery housing closable by means of a housing cover. Each of the plurality of battery cells is arranged, i.e., positioned in an interior of the battery housing. The respective battery housing thus comprises or encloses the plurality of battery cells, whereby they are delimited by means of the battery housing in relation to an environment or an external area surrounding the battery housing or adjoining the battery housing. The battery housing can preferably sealed and/or closed airtight by means of the housing cover and can be made of a metallic material, in particular aluminum.

The housing cover includes a layer composite having an envelope layer and a metal plate arranged on the envelope layer. The housing cover is thus manufactured in sandwich construction, wherein the layer composite can also be understood as a stack and/or a stacked layer sequence. The envelope layer is designed in particular for the purpose of electromagnetically shielding the interior of the battery housing in the area of the housing cover. An electromagnetic compatibility of the battery, i.e., an undesired mutual influence of the battery and an electrical and/or electronic device in an area of effect of the battery can thus be prevented and malfunction-free operation can be ensured. The envelope layer can be manufactured from a metallic material, for example from aluminum, and can have, for example, a thickness of 0.5 to 1 mm.

Furthermore, the layer composite comprises the metal plate. A metal plate in the meaning of the invention is explicitly not understood to include limp metal foil, the dimensional stability of which is only provided by application to a dimensionally-stable carrier medium. The metal plate already has dimensional stability before being arranged on the envelope layer, which in comparison to the flat metal foil has a higher modulus of elasticity, a higher axial rigidity, and a lesser deformation as a result of a force and/or torque strain. The metal plate is thus in particular a metal plate thicker in comparison to the metal foil. In particular, the metal plate has a plate thickness greater than 100 μm and preferably greater than 1 mm. Furthermore, the metal plate is thermally and/or mechanically more stable than the envelope layer. A resistance of the metal plate to thermal strain, i.e., high temperatures, and/or mechanical strain, i.e., a force and/or torque strain, is thus greater than that of the envelope layer. The metal plate can be manufactured from steel, for example.

The layer composite is arranged on the battery housing in such a way that the metal plate faces toward the interior of the battery housing. The envelope layer thus delimits the battery housing in the area of the housing cover to the outside in relation to the adjoining environment or the outside area. Such an arrangement advantageously has the result that the envelope layer is protected from a gas jet and/or fire jet escaping in case of damage to the respective battery cell.

To provide the mechanical and/or thermal resistance of the metal plate, the metal plate can be manufactured in particular from a material which differs from that of the envelope layer and/or the battery housing. Alternatively or additionally, the same material can be used, wherein to provide the mechanical and/or thermal resistance, the material additionally experiences, for example, heat treatment, shaping, and/or thermo-mechanical treatment.

The advantage thus results due to the invention that the electromagnetically shielding envelope layer is thermally and/or mechanically protected against the gas jet and/or fire jet escaping in case of damage. The gas jet and/or fire jet is prevented from destroying, burning through, or breaking through the envelope layer and thus changing its properties, for example its shape and/or an electromagnetic shielding capacity.

One advantageous embodiment provides that the metal plate is manufactured from a ferrous material and the envelope layer is manufactured from a nonferrous material. The metal plate and the envelope layer thus each comprise a metallic material different from one another. The ferrous material forming the metal plate is preferably a formable steel having a carbon content less than 2%. The nonferrous material forming the envelope layer can be, for example, a pure nonferrous metal, in particular a light metal such as aluminum, or a metal alloy having a pure iron proportion less than 50%, in particular an aluminum alloy. A respective local requirement for the housing cover can also be addressed selectively, i.e., deliberately here by means of the respective material. The metal plate manufactured from the ferrous material can thus provide a protection from the nonoperational mechanical and/or thermal strain, which results from the gas jet and/or fire jet, in the direction of the interior. Such a strain comprises, for example an elevated pressure, an elevated temperature, and/or an elevated abrasive wear in comparison to normal operation of the battery. At the same time, the electromagnetic compatibility of the battery and its protection from external strain can be ensured by means of the envelope layer. External strain can be understood, for example as an impact on and/or crushing of the battery. The housing cover can be manufactured particularly cost-effectively and robustly by means of the above-mentioned materials.

A further advantageous embodiment provides that the layer composite is made at least partially corrosion resistant. At least one section of the layer composite is thus protected from an electrochemical, chemical, and/or metal-physical reaction, which can result in an appearance of corrosion and possibly in corrosion damage. For this purpose, the metal plate is preferably manufactured from a rustproof steel. The advantage results in this way that an additional corrosion treatment, for example a separate application of a corrosion protection to a surface of the metal plate, can be omitted. To provide a corrosion and/or asset protection, such a rustproof steel has a proportion of more than 10.5% chromium. Alternatively or additionally, a corrosion coating coats the metal plate and/or an outer envelope of the layer composite. In this context, the corrosion coating, i.e., a coating, of the metal plate and/or the layer composite can be formed as a passive and/or active corrosion protection. The corrosion coating is preferably implemented as cathodic dip coating (CDC), wherein the metal plate is coated as such in a dip bath before being arranged on the envelope layer and/or after the arrangement of the layer composite. The advantage results in this way that a corrosion resistance of the metal plate and/or the layer composite remains unconsidered during the manufacturing of the housing cover and the corrosion protection can be applied flexibly as needed only at a later point in time.

A further advantageous embodiment provides that the envelope layer and the metal plate are connected to one another by means of a materially-bonding joining method. The metal plate and the envelope layer are thus respective joint parts having a geometrically defined shape, wherein a cohesion between the two joint parts is produced and/or enhanced at the joints, i.e., in a contact area, by means of the joining method. In such a joined connection, the cohesion of the two joint parts is implemented by means of material bonding. The joining method is in particular an adhesive bonding method. That is to say, the adhesive layer and the metal plate are in particular adhesively bonded to one another. The advantage results in this way that it is a conditionally detachable joined connection and only a dimensionless auxiliary agent, i.e., an adhesive, has to be destroyed to detach them. Alternatively or additionally, the joint parts can be welded and/or soldered to one another. The joined connection can thus be made particularly robust and nondetachable.

One advantageous embodiment for this purpose provides that a joined connection of the envelope layer to the metal plate formed using the adhesive is reinforced by means of at least one clinching section. The two joint parts are thus adhesively bonded to one another and include the at least one clinching section. An epoxy resin adhesive, in particular a two-component adhesive (2C adhesive) or a one-component adhesive (1C adhesive) can be used here as the adhesive, for example. The clinching section is an area of the layer composite which is formed by means of a clinching method (clinching). In particular, this can also be a combined clinching-riveting method here. The envelope layer and the metal plate are secured on one another during curing of the adhesive by means of the at least one clinching section. Additional fixing of the two joint parts during the curing can thus advantageously be omitted. The term curing can be understood, for example as chemical curing (e.g., by polyaddition, polymerization, and/or polycondensation), physical bonding (e.g., by drying, cooling, and/or gelling), or a combined solidification mechanism. Therefore, in this case this is so called clinching adhesive bonding or hybrid joining, which is known, for example from vehicle body construction. In addition, a thermal conductivity, i.e., a thermal connection, can be increased in comparison to a joined connection exclusively comprising the adhesive. Furthermore, a strength of the layer composite can be increased in the at least one clinching section.

A further advantageous embodiment provides that the envelope layer is thermally conductively connected to the metal plate and is configured to dissipate waste heat generated in case of damage from the metal plate. A thermally conductive connection thus exists between the metal plate and the envelope layer. In case of damage, thermal strain of the metal plate which is caused by the escaping gas jet and/or fire jet can in particular be discharged in a controlled manner via the envelope layer. Passive cooling is provided by the envelope layer in this way, which prevents overheating of the metal plate and can thus maintain integrity of the housing cover in case of damage.

A further advantageous embodiment provides that a surface structure of the metal plate facing toward the interior and/or at least one fold arranged on an edge of the metal plate and oriented into the interior is formed to guide the gas jet and/or fire jet along a predetermined path in the direction of a collection container arranged on the battery housing. The gas jet and/or fire jet is thus conducted away from the metal plate in an impact area chronologically after it strikes thereon, so that the gas jet and/or fire jet flows along the predefined path. It is thus possible to prevent the gas jet and/or fire jet, in particular the particles entrained therein generally having a diameter less than 1 mm, from abrasively straining and possibly damaging a component of the battery. The component can be, for example the metal plate, at least one wall of the battery housing delimiting the interior, and/or at least one of the plurality of battery cells.

The gas jet and/or fire jet can be guided, i.e., conducted by means of the surface structure, which can be formed for this purpose, for example as at least one rib, as at least one channel, and/or as a baffle section. For this purpose, in addition to the surface structure oriented into the interior, the metal plate can include a structure on an opposing side of the metal plate, which at least partially corresponds thereto. Alternatively or additionally, the metal plate can comprise the at least one fold, which is positioned on the edge of the metal plate and faces toward the interior. This can be, for example a bend at the edge of the metal plate, which can preferably be formed as an upright fold having a bending angle of 45 to 135° in relation to a longitudinal extension of the metal plate. In particular in the case of a trough-like design of the housing cover, a lateral wall of the envelope layer can be protected from the gas jet and/or fire jet. A collection container can be configured to store, for example the particles entrained by means of the gas jet and/or fire jet. The collection container can be arranged here on the battery housing on a wall of the battery housing facing toward the interior and/or located on the exterior.

A further advantageous embodiment provides that at least one of the plurality of battery cells includes a predetermined breakthrough point, which is arranged on a side of the battery cell arranged facing toward the housing cover and wherein in case of damage the gas jet and/or fire jet first exits from the at least one predetermined breakthrough point and strikes on the metal plate. Such a breakthrough point can be defined, for example by means of a so-called bursting disk. In other words, the respective battery cell preferably includes a defined weak point and/or intended breakpoint, which yields in the event of a damage-related increased battery cell internal pressure, before other regions of the respective battery cell housing break through and/or yield. In this way, the damage-related escaping gas jet and/or fire jet can advantageously be channeled. A respective point on the housing cover is known here at which the gas jet and/or fire jet will strike. It can thus be ensured, for example that the gas jet and/or fire jet first contacts the metal plate and not the battery housing. A reinforcement of the battery housing by means of the metal plate, in particular of a housing base on which the plurality of battery cells is arranged, and/or of a housing side which laterally delimits the interior and on which the housing cover is arranged, can thus be omitted and the battery housing can be manufactured particularly simply. Material and/or weight of the battery can advantageously be saved in this way.

One advantageous embodiment for this purpose provides that in case of damage a battery cell internal pressure has a value of 5 to 10 bar, in particular 7 to 8 bar, wherein a respective battery cell is designed in such a way that upon reaching the damage-related battery cell internal pressure, the predetermined breakthrough point bursts. It is thus possible to prevent the respective battery cell from releasing a large amount of energy in an uncontrolled manner due to the thermal and/or mechanical strain.

A further advantageous embodiment provides that the gas jet and/or fire jet has a temperature caused by a cell chemistry of the respective battery cell of 600 to 1100° C., in particular 800 to 900° C. As described at the outset, the battery housing can preferably be formed from aluminum. Aluminum is known to lose its intrinsic strength from a temperature of approximately 240° C. and melting is known to begin at approximately 660° C. Accordingly, the housing cover is preferably designed to limit a temperature in the interior of the battery housing to at most 240° C., so that the intrinsic strength of aluminum is preserved.

The invention additionally relates to a motor vehicle having an embodiment of the battery according to the invention. The motor vehicle is preferably at least partially electrically drivable by means of the battery. The motor vehicle is designed as an automobile, in particular as a passenger vehicle or a utility vehicle, or as a passenger bus or a motorcycle.

The invention also includes refinements of the motor vehicle according to the invention, which include features as have already been described in conjunction with the refinements of the battery according to the invention. For this reason, the corresponding refinements of the motor vehicle according to the invention are not described once again here.

The invention also comprises the combinations of the features of the described embodiments.

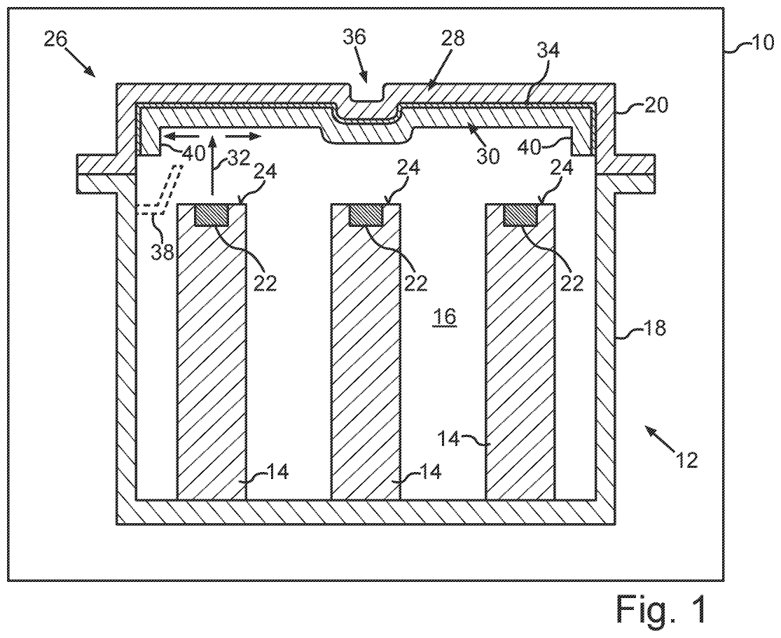

Exemplary embodiments of the invention are described hereinafter. For this purpose, the FIG. 1 shows a schematic view of a motor vehicle having a battery in a sectional illustration.

The exemplary embodiments explained hereinafter are preferred embodiments of the invention. In the exemplary embodiments, the described components of the embodiments each represent individual features of the invention to be considered independently of one another, which also refine the invention independently of one another. Therefore, the disclosure is also to comprise combinations of the features of the embodiments other than those shown. Furthermore, the described embodiments can also be supplemented by further ones of the above-described features of the invention.

### BRIEF DESCRIPTION

In the FIG. 1, the same reference numerals each refer to elements having the same function.

### DETAILED DESCRIPTION

The FIG. 1 shows a schematic illustration of a motor vehicle 10 with a sectional illustration of a battery 12, which at least partially drives the motor vehicle 10. The battery 12 shown includes three battery cells 14 by way of example. The battery cells 14 are arranged in an interior 16 of a battery housing 18 of the battery 12, wherein the interior 16 is delimited by the battery housing 18 having a housing cover 20. The respective battery cell 14 includes a predetermined breakthrough point 22, which is arranged in the exemplary embodiment shown in the figure on a side 24 of the respective battery cell 14 which faces toward the housing cover 20. The housing cover 20 includes a layer composite 26, which comprises an electromagnetically shielding envelope layer 28 and a metal plate 30 arranged thereon, for example as an insert. The envelope layer 28 can be manufactured from a ferrous material and the metal plate 30 can be manufactured as an aluminum material. To provide corrosion protection for the layer composite 26, the metal plate 30 can be manufactured from a rustproof steel. Alternatively or additionally, a corrosion coating can be provided.

It is shown as an example in the figure that a case of damage occurs in the battery cell 14 arranged on the far left. Gas accordingly develops in the battery cell 14. The battery cell internal pressure of the battery cell 14 which increases in this way has the result that the breakthrough point 22 bursts at approximately 5 to 10 bar. A thermal reaction of the battery cell 14 thus results in thermal runaway at temperatures of approximately 600 to 1100° C. As a result, a fire jet and/or gas jet 32 escapes from the breakthrough point 22 according to an arrow shown in the figure. As described, the thermally and/or mechanically more stable metal plate 30 protects the envelope layer 28 from the thermal and/or mechanical action of the escaping gas jet and/or fire jet 32.

To provide the housing cover 20, the envelope layer 28 can be connected to the metal plate 30 by means of an adhesive 34, i.e., adhesively bonded. This can be in particular a so-called construction or structural adhesive. Such a materially-bonded joined connection can be reinforced by means of a schematically outlined clinching section 36, for example using a so-called clinch rivet, which secures the envelope layer 28 and the metal plate 30 with one another during curing of the adhesive 34. Furthermore, such a joined connection can connect the envelope layer 28 to the metal plate 30 in a thermally conductive manner, so that waste heat of the gas jet and/or fire jet 32 generated in case of damage can be dissipated from the metal plate 30 via the envelope layer 28.

In order to guide the gas jet and/or fire jet 32 striking the metal plate 30 along a predetermined path in the direction of a schematically indicated collection container 38 arranged on the battery housing 18, the metal plate 30 can include two folds 40, which are arranged on a respective edge of the metal plate 30 and extend oriented into the interior 16 or perpendicular to the main extension plane of the metal plate 30. Alternatively or additionally, the metal plate 30 can include a corresponding surface structure facing toward the interior 16. The housing cover 20 thus has shaping in critical areas, i.e., at points where the gas jet and/or fire jet 32 strikes the metal plate 30, so that local guiding takes place along the metal plate 30 and a breakthrough of the envelope layer 28 does not occur.

Overall, the examples show how a combined cover, i.e., an aluminum cover having an integrated steel plate toward the inner side of the battery system, can be provided by the invention.

1. A battery for a motor vehicle, comprising a plurality of battery cells and a battery housing having a housing cover, wherein each of the plurality of battery cells is arranged in an interior of the battery housing, wherein the housing cover includes a layer composite having an electromagnetically shielding envelope layer and a metal plate, which is arranged on the envelope layer and is more thermally and/or mechanically stable than the envelope layer, wherein the metal plate faces toward the interior of the battery housing, so that the envelope layer is protected from a gas jet and/or fire jet exiting from the respective battery cell in case of damage.

2. The battery as claimed in claim 1, wherein the metal plate is manufactured from a ferrous material and the envelope layer is manufactured from a nonferrous metal material.

3. The battery as claimed in claim 1, wherein the layer composite is made at least partially corrosion resistant, wherein for this purpose the metal plate is manufactured from a rustproof steel and/or a corrosion coating covers the metal plate and/or an outer envelope of the layer composite.

4. The battery as claimed in claim 1, wherein the envelope layer and the metal plate are connected to one another by means of a materially bonding joining method, in particular are adhesively bonded to one another.

5. The battery as claimed in claim 4, wherein a joined connection of the envelope layer to the metal plate formed using an adhesive is reinforced by means of at least one clinching section, so that the envelope layer and the metal plate are secured in relation to one another during curing of the adhesive.

6. The battery as claimed in claim 1, wherein the envelope layer is connected in a thermally conductive manner to the metal plate and is configured to dissipate waste heat generated in case of damage from the metal plate.

7. The battery as claimed in claim 1, wherein a surface structure of the metal plate facing toward the interior and/or a fold, which is arranged on an edge of the metal plate and is oriented into the interior, is designed to guide the gas jet and/or fire jet along a predetermined path in the direction of a collection container arranged on the battery housing.

8. The battery as claimed in claim 1, wherein at least one of the plurality of battery cells includes a predetermined breakthrough point, which is arranged on a side of the battery cell facing toward the housing cover, and wherein in case of damage, the gas jet and/or fire jet escapes first from the at least one predetermined breakthrough point and strikes on the metal plate.

9. The battery as claimed in claim 8, wherein in case of damage a battery cell internal pressure has a value of 5 to 10 bar, in particular of 7 to 8 bar, wherein a respective battery cell is designed in such a way that upon reaching the damage-related battery cell internal pressure, the predetermined breakthrough point bursts.

10. The battery as claimed in claim 1, wherein the gas jet and/or fire jet has a temperature caused by a cell chemistry of the respective battery cell of 600 to 1100° C., in particular of 800 to 900° C.

11. A motor vehicle having a battery as claimed in claim 1.

12. The battery as claimed in claim 2, wherein the layer composite is made at least partially corrosion resistant, wherein for this purpose the metal plate is manufactured from a rustproof steel and/or a corrosion coating covers the metal plate and/or an outer envelope of the layer composite.

13. The battery as claimed in claim 2, wherein the envelope layer and the metal plate are connected to one another by means of a materially bonding joining method, in particular are adhesively bonded to one another.

14. The battery as claimed in claim 3, wherein the envelope layer and the metal plate are connected to one another by means of a materially bonding joining method, in particular are adhesively bonded to one another.

15. The battery as claimed in claim 2, wherein the envelope layer is connected in a thermally conductive manner to the metal plate and is configured to dissipate waste heat generated in case of damage from the metal plate.

16. The battery as claimed in claim 3, wherein the envelope layer is connected in a thermally conductive manner to the metal plate and is configured to dissipate waste heat generated in case of damage from the metal plate.

17. The battery as claimed in claim 4, wherein the envelope layers connected in a thermally conductive manner to the metal plate and is configured to dissipate waste heat generated in case of damage from the metal plate.

18. The battery as claimed in claim 5, wherein the envelope layer is connected in a thermally conductive manner to the metal plate and is configured to dissipate waste heat generated in case of damage from the metal plate.

19. The battery as claimed in claim 2, wherein a surface structure of the metal plate facing toward the interior and/or a fold, which is arranged on an edge of the metal plate and is oriented into the interior, is designed to guide the gas jet and/or fire jet along a predetermined path in the direction of a collection container arranged on the battery housing.

20. The battery as claimed in claim 3, wherein a surface structure of the metal plate facing toward the interior and/or a fold, which is arranged on an edge of the metal plate and is oriented into the interior, is designed to guide the gas jet and/or fire jet along a predetermined path in the direction of a collection container arranged on the battery housing.
